(19) United States
(12) Patent Application Publication
(10) Pub. No.: US 2018/0264383 A1
(43) Pub. Date: Sep. 20, 2018

(54) SYSTEM AND METHOD FOR OIL FILTRATION IN BYPASS MODE

(71) Applicant: Cummins Filtration IP, Inc., Columbus, IN (US)

(72) Inventors: Sonali Bisurkar, Sangli (IN); Amit S. Wankhede, Pune (IN); Hariprasad M. Bhalerao, Pune (IN); Shrikant A. Kamble, Pune (IN); Christopher E. Holm, Madison, WI (US); Peter K. Herman, Stoughton, WI (US); Arun P. Janakiraman, Stoughton, WI (US)

(73) Assignee: Cummins Filtration IP, Inc., Columbus, IN (US)

(21) Appl. No.: 15/761,205

(22) PCT Filed: Sep. 20, 2016
(86) PCT No.: PCT/US2016/052612

§ 371 Date: Mar. 19, 2018

Related U.S. Application Data
(60) Provisional application No. 62/222,975, filed on Sep. 24, 2015.

(51) Int. Cl. B01D 35/147; B01D 29/11; B01D 29/54; B01D 29/60; B01D 35/00; F01M 11/03

(52) U.S. Cl. CPC B01D 35/1475; B01D 29/114; B01D 29/54; B01D 2201/167; B01D 35/005; F01M 11/03; B01D 2201/298; B01D 29/606

(57) ABSTRACT

A filter cartridge having a bypass filtration media is described. The filter cartridge includes main filtration media. In some arrangements, the main filtration media includes first filtration media and second filtration media that has a different filtering efficiency than the first filtration media. The filter cartridge is configured to be installed in a filtration system having a bypass mode. While in the bypass mode, fluid passing through the filtration system is allowed to bypass the main filtration media. To avoid unfiltered fluid from passing from the inlet of filtration system to the outlet (e.g., and on to an internal combustion engine), the fluid flows through the bypass filtration media (e.g., during cold start conditions). In some arrangements, the bypass filtration media has a lower filtering efficiency than the main filtration media.

### CROSS-REFERENCE TO RELATED APPLICATIONS

The present application is related to and claims priority to U.S. Provisional Patent Application No. 62/222,975, entitled “SYSTEM AND METHOD FOR OIL FILTRATION IN BYPASS MODE,” filed on Sep. 24, 2015, by Bisurkar et al., the contents of which are herein incorporated by reference in the entirety and for all purposes.

### TECHNICAL FIELD

The present application relates to filtration systems.

### BACKGROUND

Internal combustion engines generally combust a mixture of fuel (e.g., gasoline, diesel, natural gas, etc.) and air. Lubrication oil is also supplied to the engine to lubricate the various moving components of the engine. Either prior to entering the engine or during engine operation, the intake air, fuel, lubrication oil, and other fluids are typically passed through filtration systems to remove contaminants (e.g., dust, water, oil, etc.) from the fluids. The filtration systems include filter elements having filter media. As the fluid passes through the filter media, the filter media removes at least a portion of the contaminants in the fluid.

Some filtration systems, such as oil filtration systems, may include a bypass valve. When the bypass valve is opened, the filtration system is operating in a bypass mode. While in the bypass mode, the fluid being filtered (e.g., oil) is allowed to bypass at least a primary filter element of the filtration system. For example, some oil filtration systems utilize a bypass mode on cold start while the oil is viscous and not easily passed through the primary filter element. In such systems, the bypass mode ends once the oil warms up and becomes thin enough to efficiently pass through the primary filter element. However, if dirty fluid bypasses the filter element during the bypass mode, the dirty fluid may damage the internal combustion engine.

### SUMMARY

One example embodiment relates to a filtration system. The filtration system includes a housing having a fluid inlet and a fluid outlet, a filter element, and a bypass valve. The filter element is positioned within the housing and is configured to filter a fluid. The filter element includes a main filter cartridge having a main filter media. The main filter media may be formed into a cylindrical shape. The main filter media is positioned between a first endplate and a second endplate. The first endplate includes a bypass opening. The filter element further includes bypass filter media coupled to the first endplate and covering the bypass opening. The filtration system includes a bypass valve that can be opened and closed to toggle between a normal operation mode and a bypass operation mode. When the bypass valve is open, the bypass operation mode is activated, and fluid being passed through the filtration system can bypass the main filter cartridge by flowing through the bypass filter media and through the bypass opening.

Another example embodiment relates to a filter element. The filter element includes a main filter cartridge having main filter media. The main filter media is positioned between a first endplate and a second endplate. The first endplate includes a bypass opening. The filter element further includes bypass filter media coupled to the first endplate and covering the bypass opening. The filtration system includes a bypass valve that can be opened and closed to toggle between a normal operation mode and a bypass operation mode. When the bypass valve is open, the bypass operation mode is activated and fluid being passed through the filtration system can bypass the main filter cartridge by flowing through the bypass filter media and through the bypass opening.

A further example embodiment relates to a filter element. The filter element includes a first endplate, a second endplate, and a first filter media positioned between the first endplate and the second endplate. The filter element further includes a third endplate positioned on an opposite side of the second endplate, a fourth endplate, and a second filter media positioned between the third endplate and the fourth endplate. The second filter media has a different filtering efficiency than the first filter media. The filter element includes a bypass valve positioned within a central opening of the filter element. The bypass valve can be opened and closed to toggle between a normal operation mode and a bypass operation mode. When the bypass valve is open, the bypass operation mode is activated and fluid being passed through the filter element can bypass the first filter media by flowing through the second filter media. When the bypass valve is closed, the normal operation mode is activated and fluid being passed through the filter element does not bypass the first filter media.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 shows a show cross-sectional view of a filtration system according to an example embodiment.

FIGS. 2 through 4 show perspective views of various components of the filtration system of FIG. 1.

FIGS. 5 and 6 show cross-sectional views of the filtrations system of FIG. 1 when operating in a bypass mode.

FIGS. 7A and 7B show cross-sectional views of a filtration system according to another example embodiment.

FIGS. 8 and 9 show cross-sectional views of filter media of the filtration system of FIGS. 7A and 7B.

FIGS. 10A and 10B shows various testing parameters and testing data of the filtration system of FIGS. 7A and 7B.

### DETAILED DESCRIPTION

Referring to the figures generally, a filter cartridge having a bypass filtration media is described. The filter cartridge includes main filtration media. In some arrangements, the main filtration media includes first filtration media and second filtration media that has a different filtering efficiency than the first filtration media. The filter cartridge is configured to be installed in a filtration system having a bypass mode. While in the bypass mode, fluid passing through the filtration system is allowed to bypass the main filtration media. To avoid unfiltered fluid from passing from the inlet of filtration system to the outlet (e.g., and on to an internal combustion engine), the fluid flows through the bypass filtration media (e.g., during cold start conditions). In some arrangements, the bypass filtration media has a lower filtering efficiency than the main filtration media.

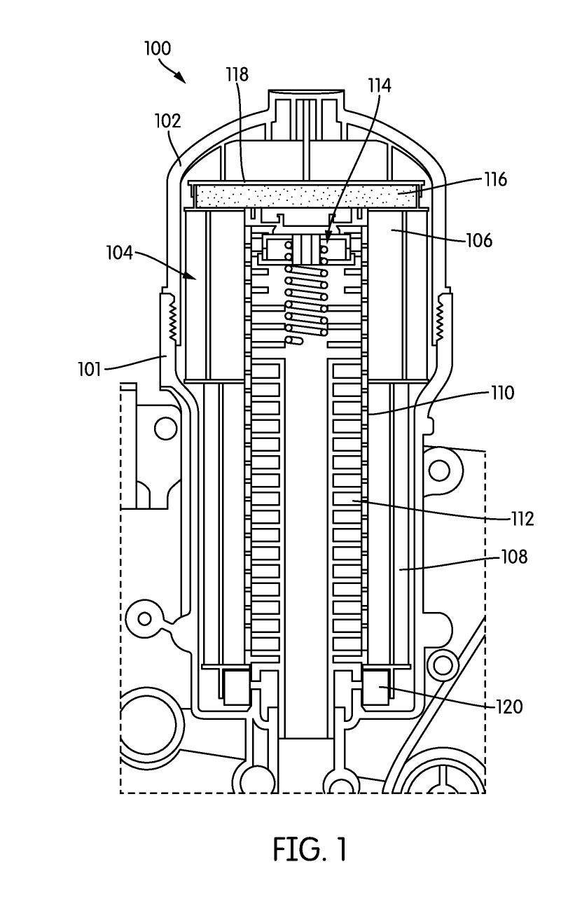

Referring to FIG. 1, a cross-sectional view of a filtration system 100 is shown according to an example embodiment. The filtration system includes a housing comprising a housing body 101 and a housing lid 102 that receives a filter element 104. The housing lid 102 is removably threaded to the housing body 101. The filter element 104 depicted in FIG. 1 is a substantially cylindrical filter element. However, the filter element 104 may possess other shapes in different embodiments. In some arrangements, the filter element 104 includes two filter cartridges: a first main filtration cartridge 106 and a second main filtration cartridge 108. The first main filtration cartridge 106 includes first main filtration media positioned between a first endplate and a second endplate. The second main filtration cartridge 108 includes second main filtration media positioned between a third endplate and a fourth endplate. In some arrangements, the third endplate and the second endplate are opposing sides of a single endplate. The second main filtration media may have a different filtering efficiency than the first main filtration media. The main filtration cartridges 106 and 108 are coupled to a center tube 110. In other arrangements, the filter element 104 includes a single main filter cartridge. When the filter element 104 is received within the housing body 101 (e.g., as shown in FIG. 1), the center tube 110 surrounds a standpipe 112 of the filtration system 100.

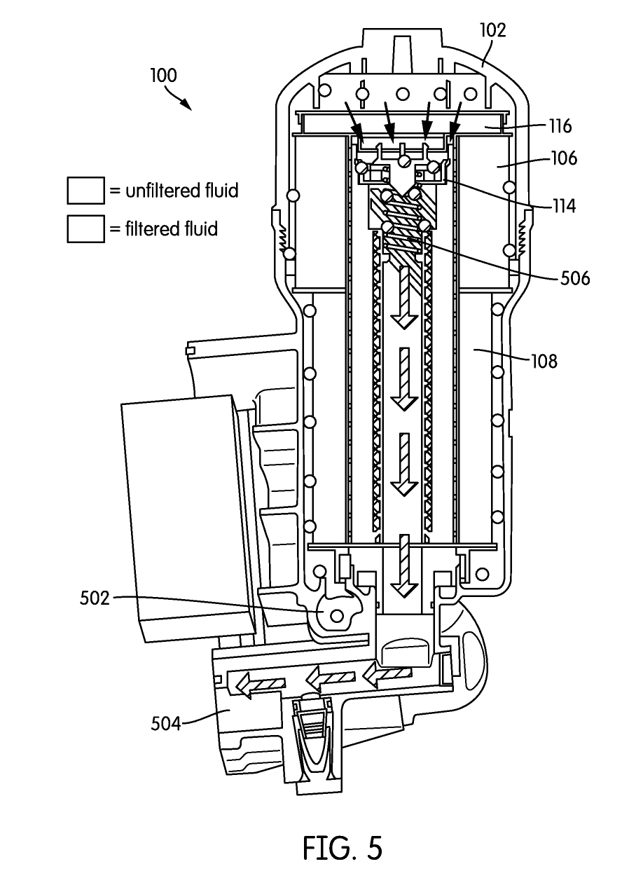

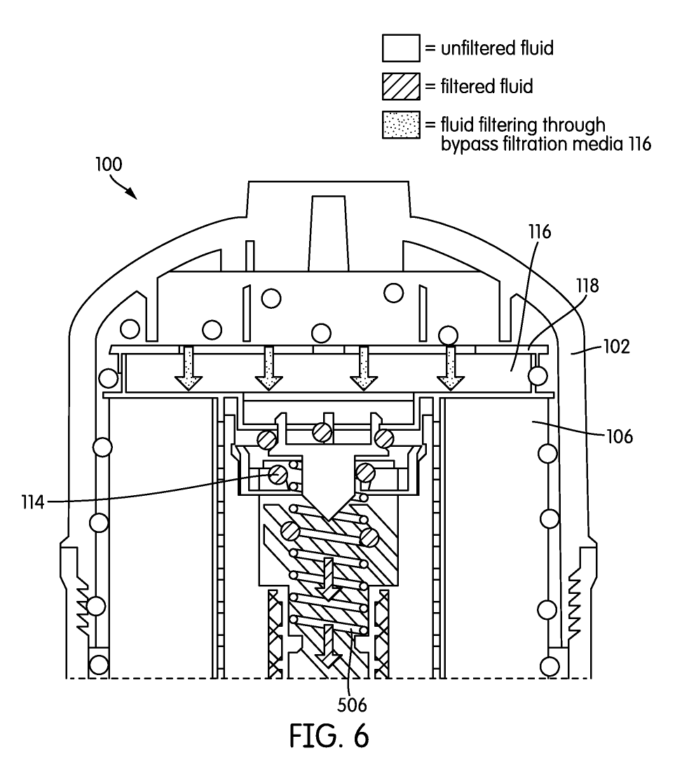

The filtration system 100 includes a bypass valve 114 that is opened and closed to toggle between a normal operation mode and a bypass operation mode. As described in further detail below with respect to FIGS. 5 and 6, when the bypass valve 114 is open, the filtration system 100 is placed in a bypass mode. While in the bypass operation mode, fluid being passed through the filtration system 100 can bypass the main filtration cartridges 106 and 108. During the bypass mode, the fluid passes through a bypass opening in the first or top endplate of the first main filtration cartridge 106 that is covered by bypass filtration media 116. The bypass filtration media 116 is a porous media that is integrated along a top axial end of the filter element 104 to ensure that liquid passing through the filtration system 100 is filtered when the filtration system 100 is in the bypass mode. The bypass filtration media 116 is positioned on an axial end of the filter element between the housing lid 102 and a top endplate of the first main filtration cartridge 106. In some arrangements, a bypass media endplate 118 is used to secure the bypass filtration media 116 to the top endplate of the first main filtration cartridge 106. The porous media selected for the bypass filtration media 116 can vary based on application and cleanliness requirements. The porous media selected for the bypass filtration media 116 may be sponge media, layered wire mesh, stacked media, a layer of solid porous media, or the like. In some arrangements, the bypass filtration media 116 has a lower filtration efficiency than the first and second filtration media. The bypass filtration media 116 is integrated with the filter element 104 and thus is changed during each filter element change service.

The filtration system 100 also includes an X-seal 120. The X-seal 120 forms a seal between the filter element 104 and the standpipe 112, which prevents fluid from bypassing the filter element 104. When the filter element 104 is being removed from the housing body 101 (e.g., during a service or filter element replacement operation), the X-seal 120 may permit residual fluid remaining in the housing body 101 to drain out of the housing body 101 (e.g., back to a fluid tank, such as an oil or fuel tank).

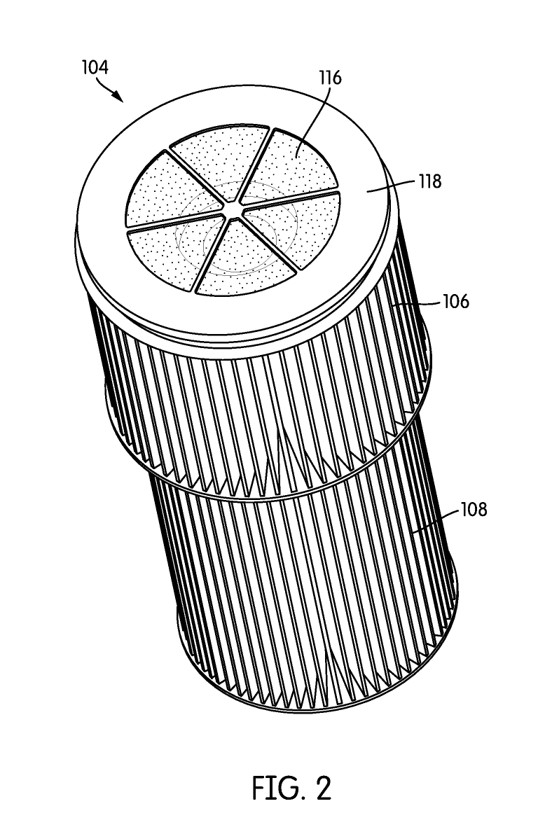

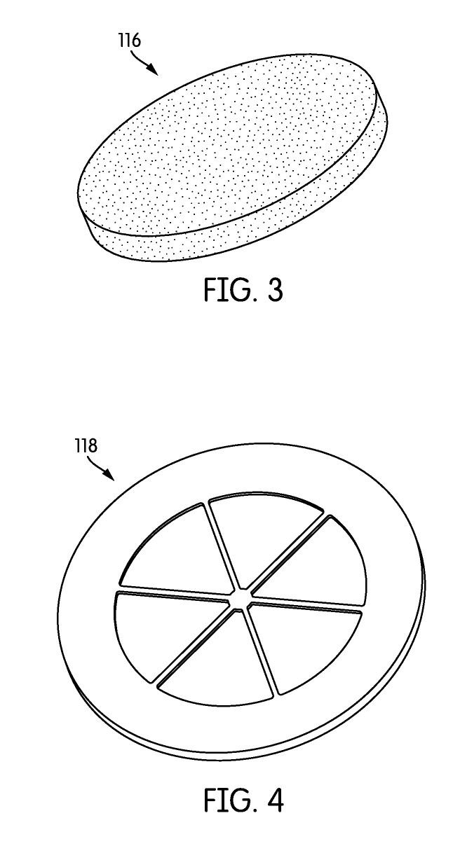

Referring to FIG. 2, a perspective view of the filter element 104 is shown. In the embodiment depicted herein, the first main filtration cartridge 106 and the second main filtration cartridge 108 are substantially cylindrical in shape. The bypass filtration media 116 is disc-shaped. The bypass filtration media 116 is secured to a first end of the first main filtration cartridge 106 through the bypass media endplate 118. Perspective views of the bypass filtration media 116 and the bypass media endplate 118 are shown in FIGS. 3 and 4, respectively.

Referring to FIGS. 5 and 6 show cross-sectional views of the filtration system 100 during bypass mode operation. Accordingly, FIGS. 5 and 6 show the bypass valve 114 in the open position. During operation, fluid to be filtered (e.g., oil; designated by the non-hashed dots/arrows) flows into the housing body 101 via an inlet 502. The fluid to be filtered pass through the filter element 104 (e.g., through the first and second main filtration cartridges 106 and 108 during normal operation, through the bypass filtration media 116 during bypass mode operation). The filtered fluid (designated by the hashed dots/arrows) exits the housing through an outlet 504. The bypass valve 114 is normally biased to the closed position by a spring 506. During certain operating conditions where the fluid being filtered is viscous and/or thick (e.g., when the oil is cold during a cold start operation), the pressure between the housing body 101 and the filter element 104 forces the bypass valve 114 into an open position thereby toggling the bypass mode operation. Once the oil warms and thins, the oil can pass through the main filtration cartridges 106 and 108 thereby reducing the pressure between the housing body 101 and the filter element 104, which allows the bypass valve 114 to close. During the bypass mode operation, the fluid passing through the filtration system 100 is still filtered through the bypass filtration media 116.

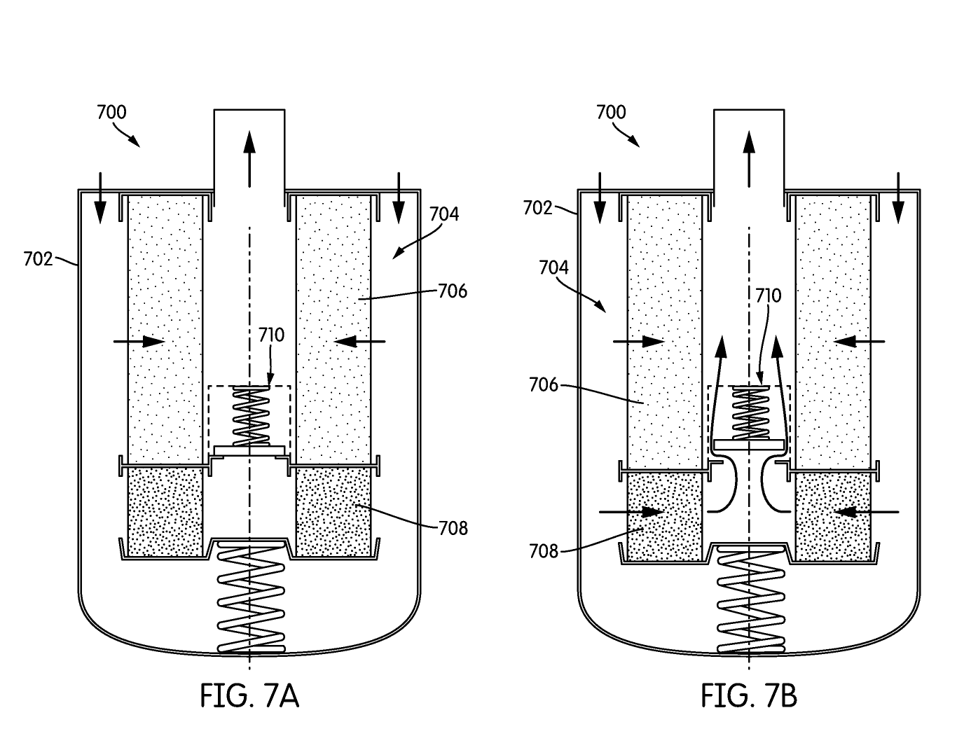

Referring to FIGS. 7A and 7B, a filtration system 700 is shown according to another example embodiment. The filtration system 700 includes a shell housing 702 that defines a filtering compartment. A filter element 704 is received within the filtering compartment. In the particular embodiment shown in FIGS. 7A and 7B, the filter element 704 is a substantially cylindrical filter element. In some arrangements, the shell housing 702 and the filter element 704 form a spin-on type filter assembly. However, the filter element 704 may possess other shapes in different embodiments. In some arrangements, the filter element 704 includes two filter cartridges: a first main filtration cartridge 706 and a second main filtration cartridge 708. The first main filtration cartridge 706 includes first main filtration media positioned between a first endplate and a second endplate. The second main filtration cartridge 708 includes second main filtration media positioned between a third endplate and a fourth endplate. In some arrangements, the third endplate and the second endplate are opposing sides of a single endplate. The second main filtration media may have a different filtering efficiency than the first main filtration media. In certain arrangements, the second main filtration media is a bypass filtration media.

The filter element 704 includes a bypass valve 710. The bypass valve 710 is positioned within a central opening of the filter element 704. As shown by the fluid flow arrows, the bypass valve 710 is positioned downstream of the filter media in a flow direction. In an alternative arrangement, the bypass valve is positioned upstream of the second main filtration cartridge 708. In such an arrangement, the second main filtration cartridge 708 may be generally sealed (e.g., surrounded by a sealing element) unless the bypass valve 710 is open. During hot or normal fluid operating conditions (i.e., when the fluid being filtered by the filtration system 700 is thin enough to flow through the first main filtration cartridge 706 media), the bypass valve 710 is closed, and fluid does not pass through the second main filtration cartridge 708. The hot or normal fluid operating condition is shown in FIG. 7A. During cold or plugged full-flow operating condition (i.e., during a cold start condition when the fluid is too vicious to efficiently pass through the first main filtration cartridge 706 media, when the first main filtration cartridge 706 media is plugged, etc.) the pressure of the fluid forces the bypass valve 710 to open thereby allowing the fluid to pass through the second main filtration cartridge 708. The cold or plugged full-flow operating condition is shown in FIG. 7B. In the cold or plugged full-flow operating condition, the majority of liquid flow takes place through the second main filtration cartridge 708 and a small portion of the of the liquid flow takes place through the first main filtration cartridge 706.

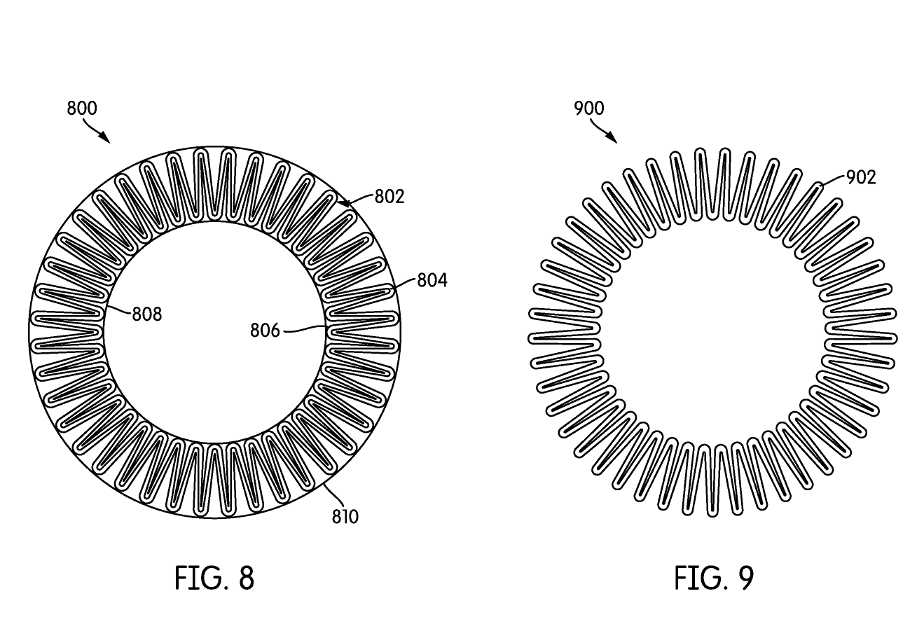

Referring to FIG. 8, a cross-sectional view of pleated filter media 800 is shown. In some arrangements, filter media 800 is the filter media used in the first main filtration cartridge 706 of FIGS. 7A and 7B. The pleated filter media 800 includes a full flow multi-layer pleated synthetic media 802 having an outer layer 804 and an inner layer 806. The inner layer 806 may have different filtering characteristics than the outer layer 804. In some arrangements, the pleated filter media 800 includes an inner wire-screen support layer 808 and/or an outer wire-screen support layer 810. Filter media 800 forms a “tight” media that has a higher filtering efficiency than a bypass filter media (e.g., filter media 900 as discussed below).

Referring to FIG. 9, a cross-sectional view of pleated filter media 900 is shown. In some arrangements, filter media 900 is the filter media used in the second main filtration cartridge 708 of FIGS. 7A and 7B. Accordingly, the filter media 900 is bypass filter media. The pleated filter media 800 includes a pleated single-layer of coarse plain-weave wire mesh 902. The filter media 900 has a lower filtering efficiency than filter media 800.

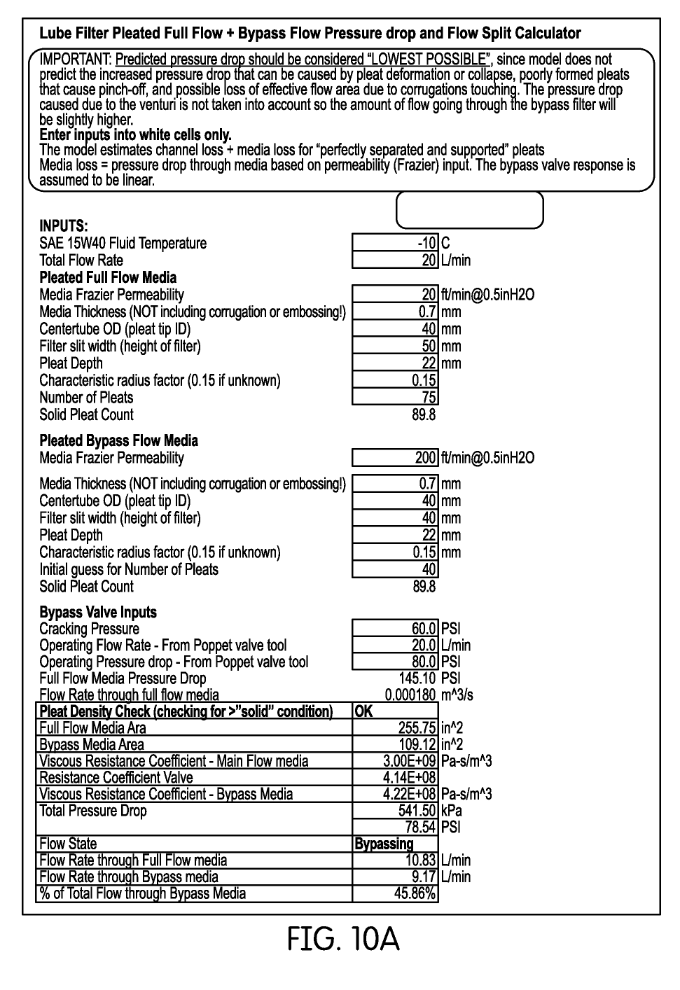

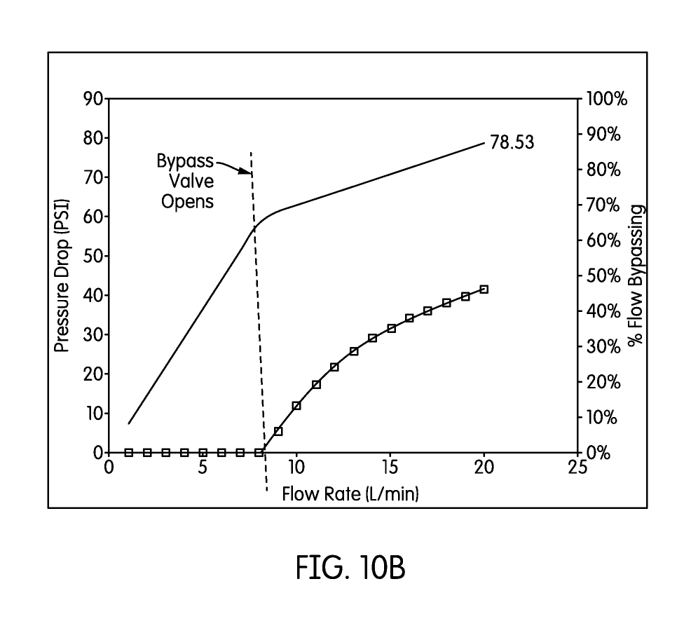

Referring to FIGS. 10A and 10B, various testing data of the filtration system 700 is shown. The testing parameters are shown in FIG. 10A. The test results based on the parameters of FIG. 10A are shown in FIG. 10B. As shown in FIG. 10B, as the bypass valve 710 opens as the flow rate through the filter element 704 increases. When the bypass valve 710 opens, a portion of the fluid being filtered passes through the second main filtration cartridge 708, which reduces the slope of the pressure drop rise for increased flow rate of fluid being filtered.

The above-described filtration system 100 that utilizes the filter element 104 with the bypass filtration media 116 ensures that liquid flowing through the filtration system 100 during bypass mode operation is filtered. This arrangement provides additional protection for internal combustion engines during cold start conditions that trigger the bypass mode operation. Additionally, the arrangement provides enhanced protection for the bypass valve 114 by reducing the amount of contaminant carried through the bypass valve during bypass mode operation.

Although the above-described filtration system 100 and filter element 104 are described in the context of an oil or lubricant filtration system, it should be appreciated that the filtration system 100 can be applied to other types of filtration system. For example, the filtration system 100 and filter element 104 may be applied to hydraulic filtration systems.

It should be noted that any use of the term “example” herein to describe various embodiments is intended to indicate that such embodiments are possible examples, representations, and/or illustrations of possible embodiments (and such term is not intended to connote that such embodiments are necessarily extraordinary or superlative examples).

The terms “coupled” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other example embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Additionally, features from particular embodiments may be combined with features from other embodiments as would be understood by one of ordinary skill in the art. Other substitutions, modifications, changes and omissions may also be made in the design, operating conditions and arrangement of the various example embodiments without departing from the scope of the present invention.

1. A filtration system comprising:
a housing having a fluid inlet and a fluid outlet;
a filter element positioned within the housing and configured to filter a fluid, the filter element including:
a main filter cartridge having main filter media, the main filter media positioned between a first endplate and a second endplate, the first endplate including a bypass opening,
a bypass media endplate, and
bypass filter media coupled to the first endplate by the bypass media endplate and covering the bypass opening;
a bypass valve that can be opened and closed to toggle between a normal operation mode and a bypass operation mode, when the bypass valve is open, the bypass operation mode is activated and fluid being passed through the filtration system can bypass the main filter cartridge by flowing through the bypass filter media and through the bypass opening.

2. The filtration system of claim 1, wherein the main filter media is formed into a cylindrical shape.

3. The filtration system of claim 1, wherein the bypass valve is positioned within a central opening of the filter element.

4. The filtration system of claim 1, wherein the bypass filter media has a lower faltering efficiency than the main filter media.

5. The filtration system of claim 1, wherein the main filter cartridge is a first main filter cartridge and the main filter media is a first main filter media, and wherein the filter element comprises the first main filter cartridge and a second main filter cartridge, the second main filter cartridge comprising a third endplate and a second main filter media, the second main filter media positioned between the second endplate and the third endplate.

6. The filtration system of claim 5, wherein the second main filter media has a different filtering efficiency than the first main filter media.

7. The filtration system of claim 1, wherein the bypass valve is biased to the normal operation mode by a spring.

8. A filter element comprising:
a main filter cartridge having main filter media, the main filter media positioned between a first endplate and a second endplate, the first endplate including a bypass opening;
a bypass media endplate;
bypass filter media coupled to the first endplate by the bypass media endplate and covering the bypass opening; and
a bypass valve that can be opened and closed to toggle between a normal operation mode and a bypass operation mode, wherein when the bypass valve is open, the bypass operation mode is activated and fluid being passed through the filtration system can bypass the main filter cartridge by flowing through the bypass filter media and through the bypass opening.

9. The filter element of claim 8, wherein the main filter media is formed into a cylindrical shape.

10. The filter element of claim 8, wherein the bypass valve is positioned within a central opening of the filter element.

11. The filter element of claim 8, wherein the bypass filter media has a lower filtering efficiency than the main filter media.

12. The filter element of claim 8, wherein the main filter cartridge is a first main filter cartridge and the main filter media is a first main filter media, and wherein the filter element comprises the first main filter cartridge and a second main filter cartridge, the second main filter cartridge comprising a third endplate and a second main filter media, the second main filter media positioned between the second endplate and the third endplate.

13. The filter element of claim 12, wherein the second main filter media has a different filtering efficiency than the first main filter media.

14. The filter element of claim 8, wherein the bypass valve is biased to the normal operation mode by a spring.

15-20. (canceled)
